(19) United States
(12) Patent Application Publication
(10) Pub. No.: US 2015/0135090 A1
(43) Pub. Date: May 14, 2015

(54) USER ADAPTIVE INTERFACE PROVIDING SYSTEM AND METHOD

(71) Applicant: SIGONGMEDIA CO., LTD, Seongnam-si (KR)

(72) Inventor: Ki Seok PARK, Seoul (KR)

(73) Assignee: SIGONGMEDIA CO., LTD, Seongnam-si (KR)

(21) Appl. No.: 14/090,562

(22) Filed: Nov. 26, 2013

(30) Foreign Application Priority Data
Nov. 11, 2013 (KR) 10-2013-0136217

(51) Int. Cl. G06F 3/01; G06F 3/0484

(52) U.S. Cl. CPC G06F 3/011; G06F 3/0484
USPC 715/745

(57) ABSTRACT

Provided are a system and a method that analyze a use environment of a user to provide a user adaptive interface suitable for the user. The system acquires an image of a user by using a camera built/equipped in a display displaying an interface, analyzes a physical use environment of the user from the acquired image, sets/changes the interface displayed by the display according to the analyzed result, and provides the set/changed interface. The system provides a user adaptive interface by using a camera which is included in general displays.

### CROSS-REFERENCE TO RELATED APPLICATIONS

This application claims priority under 35 U.S.C. §119 to Korean Patent Application No. 10-2013-0136217, filed on Nov. 11, 2013, the disclosure of which is incorporated herein by reference in its entirety.

### TECHNICAL FIELD

The present invention relates to a system and method for selecting and providing a user interface (UI) displayed by a display, and more particularly, to a user adaptive interface providing system and method that select and provide an interface to display on the basis of a use environment of a user using a display.

### BACKGROUND

As an environment using contents or applications is diversified and subdivided, an operational environment (UI/UX) of a provided service is also exposed to various environments, and thus, even one service screen more requires an appropriate operational environment depending on a use environment of a user.

Regarding such a requirement, as a method of changing an interface to be suitable for a user environment, there is a UI providing method of providing a reactive interface. However, a related art reactive interface is applied in only a limited domain such as a Web browser, and changes a service screen on the basis of only a resolution of a screen provided by a display device. For this reason, the related art reactive interface cannot wholly reflect an actual operational environment.

For example, when a UI provided to be suitable for a resolution of 1024*768 is executed in a 50 inches or 100 inches large size display device, a user is confronted with an excessively large button or a large screen unable to use. Therefore, a user adaptive interface providing method for changing an operational environment to be suitable for an actual use environment in various environments is needed.

### SUMMARY

Accordingly, the present invention provides a user adaptive interface providing system and method that acquire information about a use environment of a user by using a camera built/equipped in a display, set or change a UI displayed by the display on the basis of the acquired information, and provide the set or changed UI.

In one general aspect, a user adaptive interface providing system includes: a camera configured to acquire an image of a user using a display; an analyzer configured to analyze a physical use environment or use pattern of the user using the display on a basis of the image; and an interface provider configured to select and provide an interface to be displayed by the display on a basis of the physical use environment or the use pattern.

The analyzer may analyze, from the image, a distance between the display and the user and a relative position of the user to the display.

The analyzer may analyze, from the image, a moving direction of the user based on a movement of the user and a relative position change of the user to the display.

The interface provider may select a size of the interface on a basis of a size of the display, and provide the interface having the selected size.

The interface provider may select a position of the interface on a basis of a relative position of the user to the display, and provide the interface to the selected position.

The interface provider may change a position of the interface displayed by the display according to a movement of the user.

The interface provider may select a kind of the interface according to the use pattern of the user, and provide the selected kind of interface.

The camera may be built or equipped in the display.

In another general aspect, a user adaptive interface providing method includes: acquiring an image of a user using a display; analyzing, from the image, a physical use environment or use pattern of the user using the display; and selecting and providing an interface to be displayed by the display on a basis of at least one of the physical use environment and the use pattern.

Other features and aspects will be apparent from the following detailed description, the drawings, and the claims.

### BRIEF DESCRIPTION OF THE DRAWINGS

FIG. 1 is a block diagram illustrating a structure of a user adaptive interface providing system according to an embodiment of the present invention.

FIG. 2 is a flowchart illustrating a process of a user adaptive interface providing method according to an embodiment of the present invention.

FIGS. 3 to 14 are diagrams showing examples in which the user adaptive interface providing system according to an embodiment of the present invention provides a user adaptive interface.

FIGS. 15 and 16 are diagrams for describing a method in which the user adaptive interface providing system according to an embodiment of the present invention measures a size of a display.

### DETAILED DESCRIPTION OF EMBODIMENTS

The advantages, features and aspects of the present invention will become apparent from the following description of the embodiments with reference to the accompanying drawings, which is set forth hereinafter. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Hereinafter, embodiments of the present invention will be described in detail with reference to the accompanying drawings.

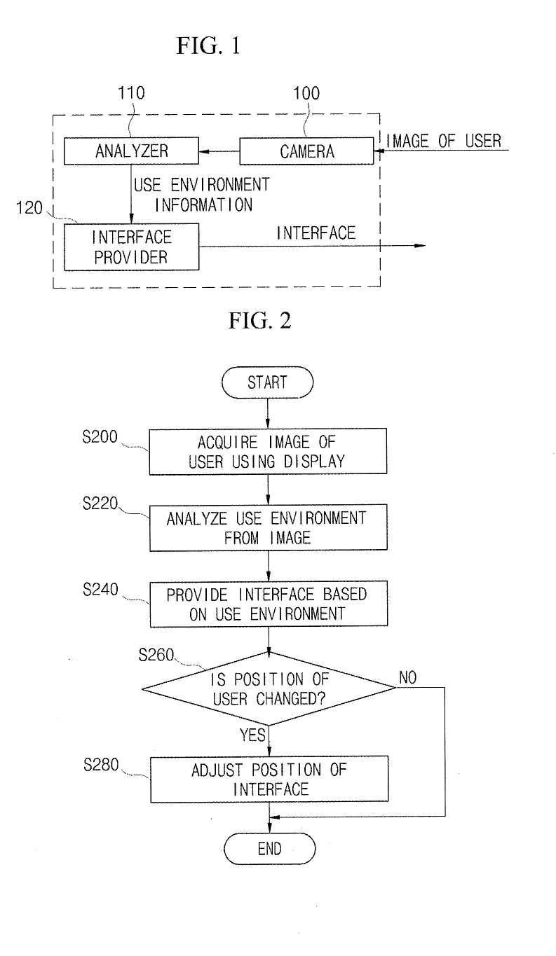

FIG. 1 is a block diagram illustrating a structure of a user adaptive interface providing system according to an embodiment of the present invention.

The user adaptive interface providing system according to an embodiment of the present invention includes a camera 100, an analyzer 110, and an interface provider 120.

The present invention is characterized by analyzing a use environment of a user by using the camera 100 built/equipped in a display and providing a UI based on the analyzed result. The camera 100 may be fundamentally built into the display, but may be used in connection with the display without being built into the display itself.

The camera 100 acquires an image of a user using the display when the display is in a usable state. The camera 100 transfers the acquired image to the analyzer 110.

The analyzer 110 analyzes the image acquired by the camera 100 to analyze a physical use environment or use pattern of the user using the display. The analyzer 110 may receive the image from the camera 100, and may continuously analyze the use environment. Alternatively, only when the initial use environment is analyzed and then the use environment such as a position of the user in the image is changed, the analyzer 100 may analyze the use environment.

The analyzer 110 analyzes a distance between the display and the user, a relative position of the user (using the display) to the display, a moving direction of the user based on a movement of the user when a position of the user using the display is changed, a relative position change of the user, etc., by using the image received the camera 100

The analyzer 110 transfers information about the physical use environment or use pattern of the user, which is analyzed from the image transferred from the camera 100, to the interface provider 120.

The interface provider 120 selects and provides an interface to be displayed by the display on the basis of an analysis result of the physical use environment or use pattern of the user transferred from the analyzer 110. Also, in response to a change in the use environment or the like of the user, the interface provider 120 may adjust a currently displayed interface to provide a new interface.

The interface provider 120 selects an interface to display on the basis of the use environment.

For example, the interface provider 120 may select a size of the interface to be displayed by the display on the basis of a size of the display to provide the interface having the selected size, select a position of the interface on the basis of the distance between the display and the user and the relative position of the user to the display to provide the interface to the selected position, and select a kind of the interface to display on the basis of the use pattern of the user using the display to provide the selected kind of interface.

A detailed example of a user interface provided by the interface provider 120 will be described below with reference to FIGS. 3 to 14.

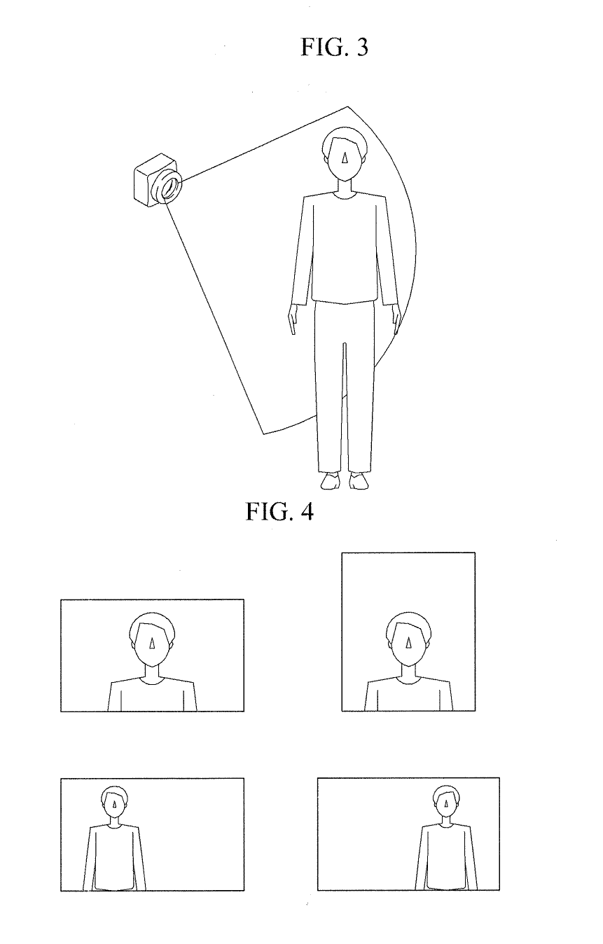

FIG. 2 is a flowchart illustrating a process of a user adaptive interface providing method according to an embodiment of the present invention.

In operation S200, the user adaptive interface providing system acquires an image of a user using a display by using a camera built/equipped in the display used to display an interface. In operation S220, the user adaptive interface providing system analyzes a physical use environment, use pattern, or the like of the user using the display from the acquired image. In operation S240, the user adaptive interface providing system selects and provides an interface suitable for the use environment on the basis of the analyzed result.

For example, the user adaptive interface providing system may select a size of the interface on the basis of a size of the display to provide the interface having the selected size, select a position of the interface on the basis of a distance between the display and the user and a relative position of the user to the display to provide the interface to the selected position, and select a kind of the interface on the basis of the use pattern of the user to provide the selected kind of interface.

Moreover, the user adaptive interface providing system detects a position change of the user based on a movement of the user even after the interface is provided in operation S260, and when a change in the position (a position of the user in a case of a large-size screen, a position of a finger of the user in a case of a display such as a tablet, or the like) of the user is detected, the user adaptive interface providing system adjusts and provides the position of the interface according to the position of the user in operation S280.

FIGS. 3 to 14 show examples of the user adaptive interface providing system according to an embodiment of the present invention provides a user adaptive interface.

FIGS. 3 to 6 show general examples of the user adaptive interface providing system according to an embodiment of the present invention provides a user adaptive interface.

As shown in FIG. 3, a camera built/equipped in a display acquires an image of a user. FIG. 4 shows an example of an image acquired by the camera, and the image acquired by the camera is an indicator that shows a distance between a user and the camera, a position of the user, and a current status of the user depending on a physical environment of the user.

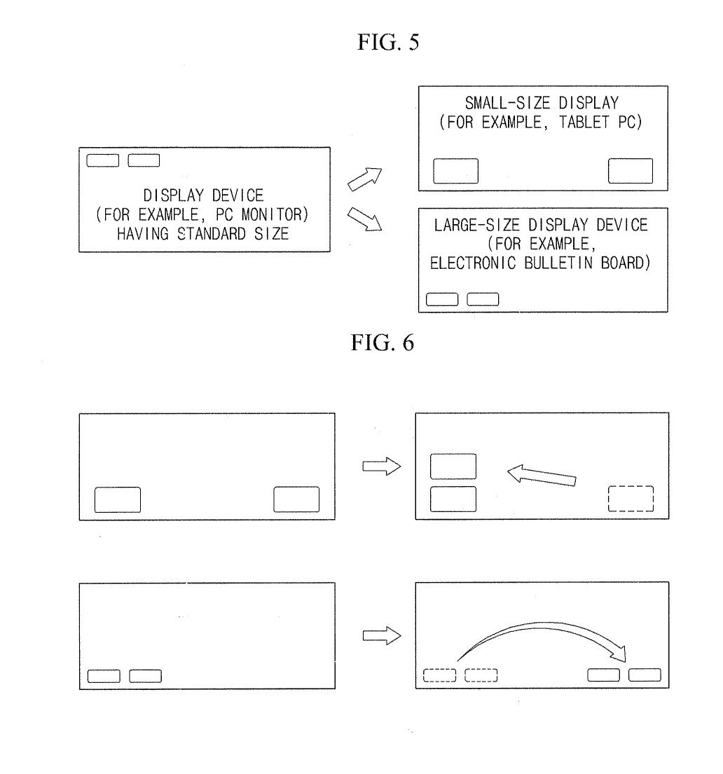

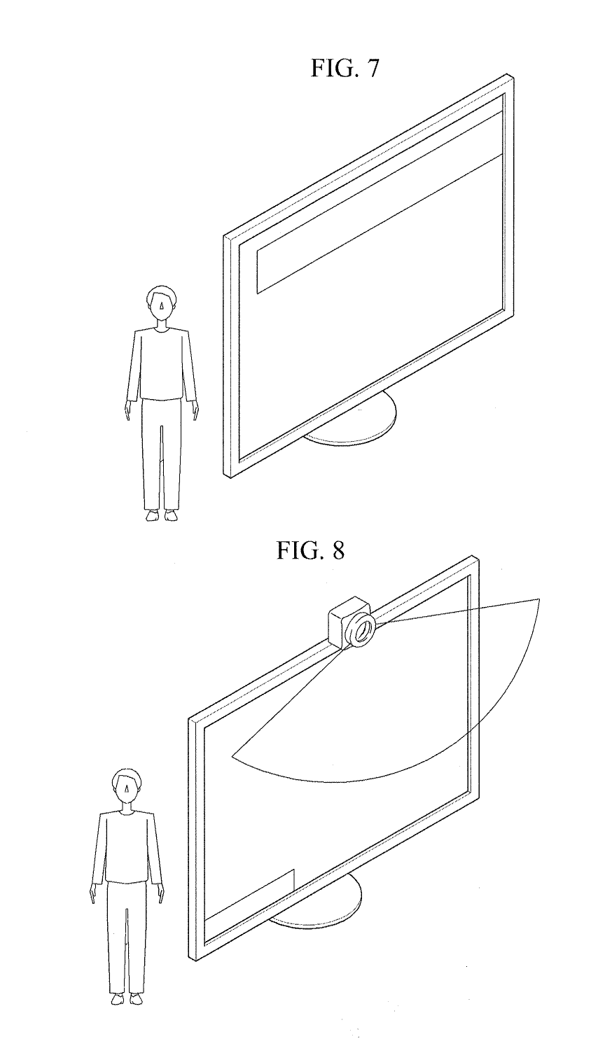

FIG. 5 shows an example that provides a suitable interface depending on a use environment, and shows an interface of which a size is adjusted when the interface generated to be suitable for a display (for, a monitor of a personal computer (PC)) having a standard size is displayed by a small-size display (for example, a tablet PC) or a large-size display (for example, an electronic bulletin board). That is, when the interface suitable for a resolution of the display having the standard size is displayed by the large-size display as-is, an excessively large interface is provided. To solve such a problem, a size of the interface is adjusted to be suitable for the size of the display, and the size-adjusted interface is provided.

FIG. 6 shows an example in which an operational environment is continuously reconstructed to have a good accessibility depending on a current position and status of a user.

An image acquired by a camera is continuously analyzed, and when a position of a user or a distance between the user and the camera is changed, by changing a position of a currently displayed interface to provide the position-changed interface, the user is provided with an easily accessible interface regardless of a use environment.

FIGS. 7 to 10 show an example in which a large-size display displays an interface.

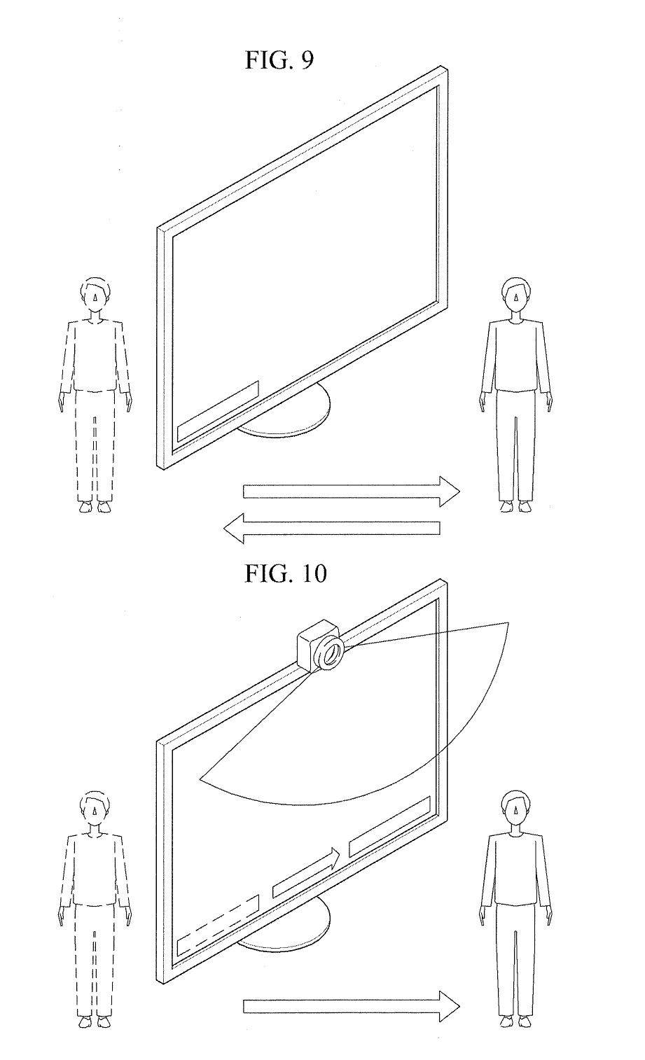

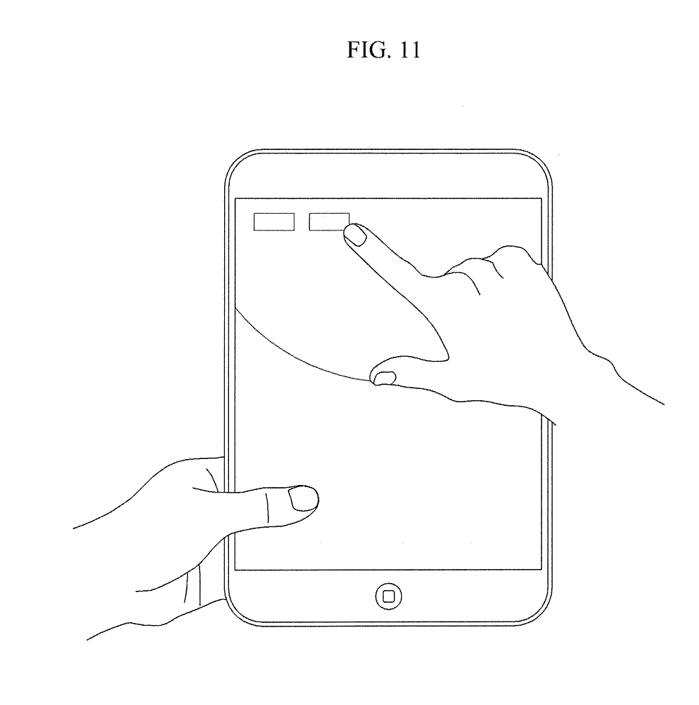

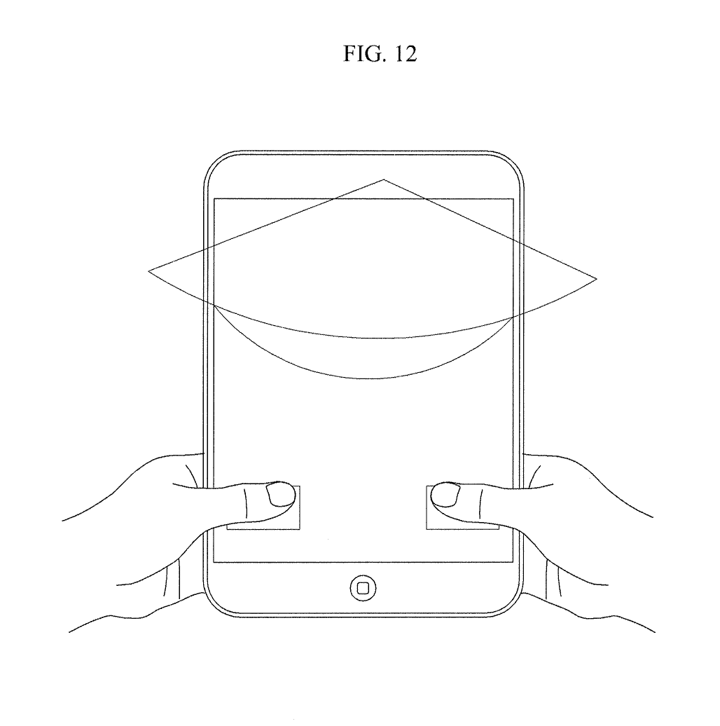

As shown in FIG. 7, when an interface optimal for a small-size display is displayed as-is, an excessively large interface is provided. For this reason, as shown in FIG. 8, a size, position, etc. of an interface is adjusted, and the adjusted interface is displayed. Furthermore, when a position change of a user is detected by a camera as shown in FIG. 9, as shown in FIG. 10, by adjusting a position of an interface, a user's convenience is maximized, and an interface suitable for a use environment is provided.

FIGS. 11 to 14 show an example in which a small-size display displays an interface.

As shown in FIG. 11, when a size of a screen is small, it is inconvenient to manipulate and access an operational environment optimized for a large-size display. Therefore, as shown in FIG. 12, the operational environment is constructed to have a size and a position which are appropriate for a user to manipulate, on the basis of a use environment analyzed by a camera of the display, and the constructed operational environment is provided, thus maximizing the user's convenience.

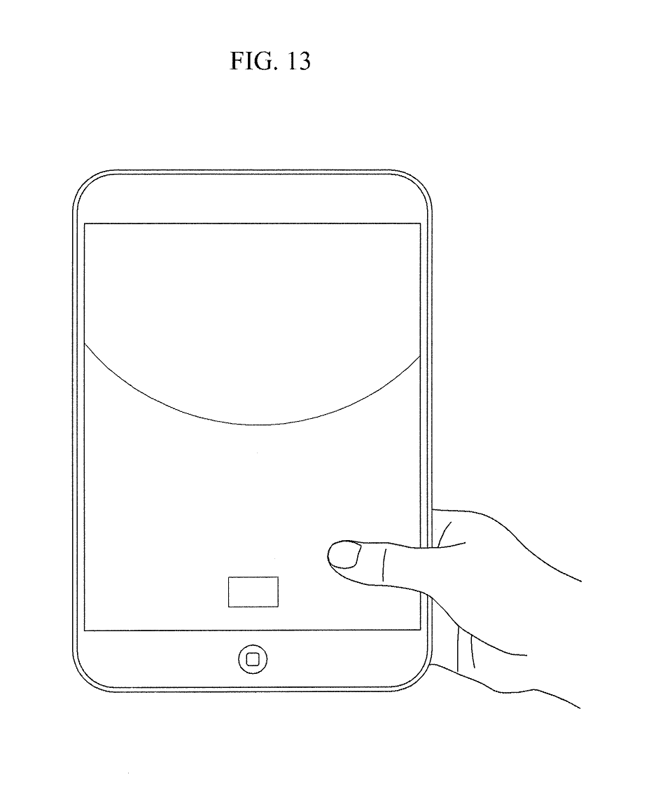

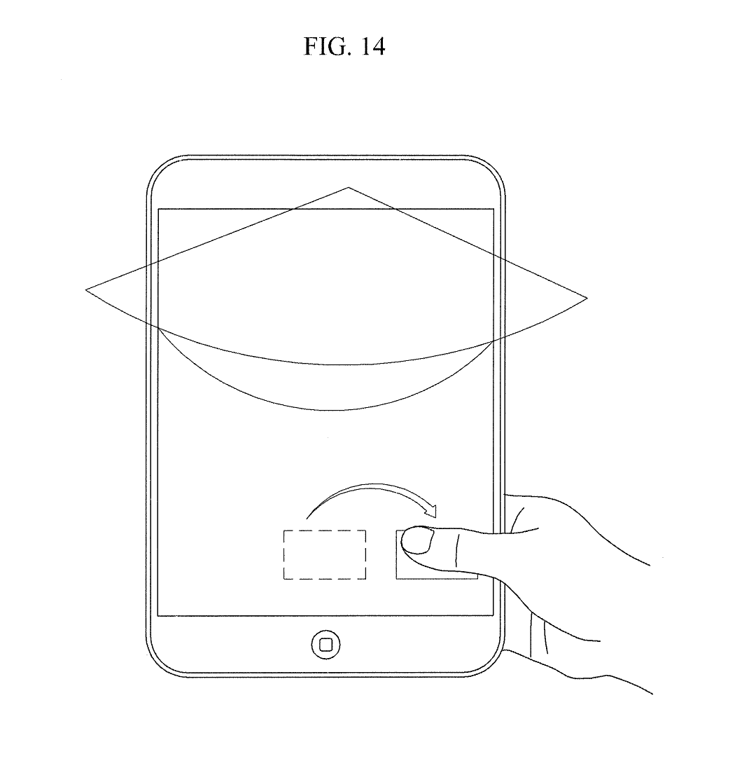

Moreover, as shown in FIGS. 13 and 14, a photographing button is mainly disposed at a central portion of a camera, and thus, when a user makes a specific motion such as self-camera photographing, it is difficult to manipulate the camera. Therefore, in a specific status, the user adaptive interface providing system according to an embodiment of the present invention may analyze the specific status (for example, a position of a finger, or the like) to change an operational environment, thereby providing an interface convenient for the user.

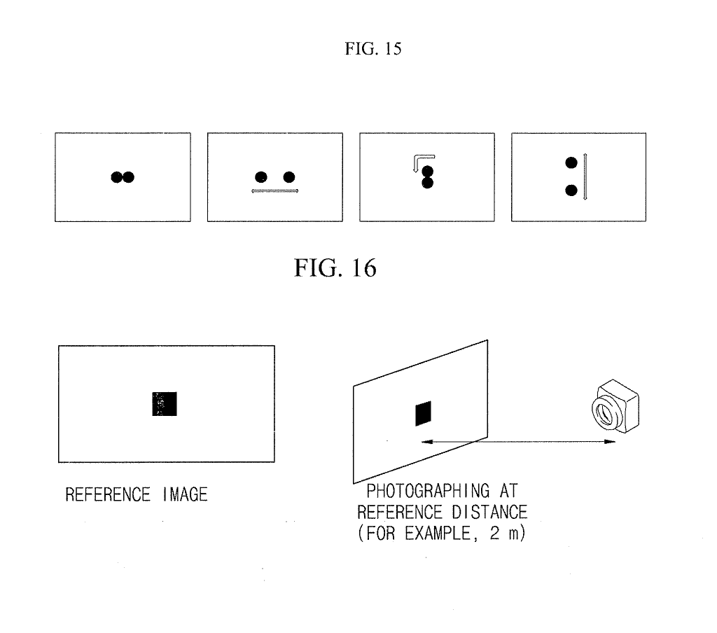

FIGS. 15 and 16 illustrates a method that specifies an actual screen size of a display in a process where the user adaptive interface providing system according to an embodiment of the present invention analyzes a use environment of a user.

FIG. 15 illustrates an example in which there is a screen touch function, and displays two dots on a full screen to allow an index finger and a middle finger to touch the two dots. By moving the index finger and middle finger move according to movements of the two dots, the two dots are opened outward to both sides, and thus, the two fingers are induced to be maximally opened.

In a case of an adult, since an average distance between the two fingers is about 90 mm, an actual width size of the screen is calculated from the average distance. In this case, since an actual ratio of the screen differs from a displayed resolution ratio of the screen, a vertical height is again measured, and thus, after the width size is measured, the two dots are rotated so that a distance between the two dots is reduced to the original distance and the two dots are vertically arranged. In the vertically arranged state, by again opening the two dots outward to upper and lower sides, the two fingers are induced to be maximally opened, and an actual height size of the screen is calculated from a distance between the opened fingers.

FIG. 16 illustrates an example in which an external camera is provided without touching a screen. A reference image (for example, a square image composed of black 500×500 pixels) having a certain size (a pixel) is displayed on the center of a full screen. The external camera captures an image of the display at the reference distance in state of vertically and horizontally adjusted. A difference between a resolution of the captured image and an actual resolution is calculated, and is used as a correction coefficient of a distorted image in photographing.

In this case, a screen resolution detected through photographing is “a screen size of the captured image/a reference image size of the captured image*an actual reference image size”, and the correction coefficient is “a screen resolution (detected through photographing)/actual screen resolution”.

The captured image provides meta information. Therefore, an actual focal length and a 35 mm film focal length may be obtained from the meta information, and an actual size may be obtained from the obtained focal length.

Photographing distance (reference distance)/focal length*sensor size*(photographed screen size/whole image size*correction coefficient)

Photographing distance (reference distance)/35 mm film conversion focal length*film size (width 36 mm, height 24 mm)*(photographed screen size/whole image size correction coefficient)

As described above, the present invention analyzes a use environment of a user by using a camera built/equipped in a display, and adjusts a UI according to the analyzed result in order for the user to easily manipulate the UI, thereby providing an interface suitable for the use environment of the user in various environments.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A user adaptive interface providing system comprising:
a camera configured to acquire an image of a user using a display;
an analyzer configured to analyze a physical use environment or use pattern of the user using the display on a basis of the image; and
an interface provider configured to select and provide an interface to be displayed by the display on a basis of the physical use environment or the use pattern.

2. The user adaptive interface providing system of claim 1, wherein the analyzer analyzes, from the image, a distance between the display and the user and a relative position of the user to the display.

3. The user adaptive interface providing system of claim 1, wherein the analyzer analyzes, from the image, a moving direction of the user based on a movement of the user and a relative position change of the user to the display.

4. The user adaptive interface providing system of claim 1, wherein the interface provider selects a size of the interface on a basis of a size of the display, and provides the interface having the selected size.

5. The user adaptive interface providing system of claim 1, wherein the interface provider selects a position of the interface on a basis of a relative position of the user to the display, and provides the interface to the selected position.

6. The user adaptive interface providing system of claim 1, wherein the interface provider changes a position of the interface displayed by the display according to a movement of the user.

7. The user adaptive interface providing system of claim 1, wherein the interface provider selects a kind of the interface according to the use pattern of the user, and provides the selected kind of interface.

8. The user adaptive interface providing system of claim 1, wherein the camera is built or equipped in the display.

9. A user adaptive interface providing method comprising:
acquiring an image of a user using a display;
analyzing, from the image, a physical use environment or use pattern of the user using the display; and
selecting and providing an interface to be displayed by the display on a basis of at least one of the physical use environment and the use pattern.

10. The user adaptive interface providing method of claim 9, wherein the acquiring of an image comprises acquiring the image of the user by using a camera built or equipped in the display.

11. The user adaptive interface providing method of claim 9, wherein the analyzing of a physical use environment comprises analyzing, from the image, at least one of a distance between the display and the user and a relative position of the user to the display.

12. The user adaptive interface providing method of claim 9, wherein the analyzing of a physical use environment comprises analyzing, from the image, a relative position change of the user to the display.

13. The user adaptive interface providing method of claim 9, wherein the selecting and providing of an interface comprises selecting a size of the interface on a basis of a size of the display to provide the interface having the selected size.

14. The user adaptive interface providing method of claim 9, wherein the selecting and providing of an interface comprises selecting a position of the interface on a basis of a relative position of the user to the display to provide the interface to the selected position.

15. The user adaptive interface providing method of claim 9, wherein the selecting and providing of an interface comprises selecting a kind of the interface on a basis of the use pattern of the user acquired from the image to provide the selected kind of interface.

16. The user adaptive interface providing method of claim 9, wherein the selecting and providing of an interface comprises continuously changing a position of the interface according to a movement of the user.
